(19) United States
(12) Patent Application Publication
(10) Pub. No.: US 2013/0099668 A1
(43) Pub. Date: Apr. 25, 2013

(54) LED LAMP WITH AN AIR-PERMEABLE SHELL FOR HEAT DISSIPATION

(71) Applicants: Hua JI, Nanjing (CN); Robert Naii Lee, Palo Alto, CA (US)

(72) Inventors: Hua JI, Nanjing (CN); Robert Naii Lee, Palo Alto, CA (US)

(21) Appl. No.: 13/276,461

(22) Filed: Oct. 19, 2011

(51) Int. Cl. H05B 37/02

(52) U.S. Cl. 315/112

(57) ABSTRACT

An LED lamp with an air-permeable shell for heat dissipation. The LED lamp comprises a lamp shell having a top end, a shell body and a bottom end. A LED light source module is bounded on the top end of the lamp shell. A screw base is jointed with the bottom end of the lamp shell. An AC/DC power conversion module is located inside the lamp shell. The lamp shell is made of thermal conductive materials and have air-permeable through holes formed on the lamp shell. With the air permeable lamp shell, the natural air convection surrounding the LED light source module is improved and the inside surface of the lamp shell also contributes to the heat dissipation. The contact surface of the lamp shell with the ambient air is significantly increased to enhance the effect of heat dissipation.

### FIELD OF INVENTION

The present invention is related generally to a LED lamp and, more particularly, to a LED lamp with an air-permeable shell for heat dissipation.

### BACKGROUND OF THE INVENTION

A LED lamp is a solid-state lamp that uses light-emitting diodes (LEDs) as the source of light. Compared with traditional white light sources, the LED light source has many advantages such as small size, high illumination efficiency, long lifetime, fast response and high reliability. With the development of LED lighting technologies, many LED lamps have become available as replacements for screw-in incandescent or compact fluorescent light bulbs, ranging from low-power 5-40 watt incandescent, conventional 60 watt incandescent bulbs to even higher wattage bulbs. As of 2010, a few LED lamps were available to replace high wattage bulbs, e.g. a 13-watt LED bulb which is about as bright as a 100 W incandescent bulb.

Along with increased power of LED lamps, the enhancement of heat dissipation to reduce the junction working temperature of high power LEDs becomes the fundamental problem of the application of LED lamps for illumination purpose. The junction working temperature of high power LED should be well controlled to avoid overheating damage, and the brightness in lumens and the lifetime of high power LEDs both are inversely proportional to the junction working temperature. In order to avoid lumen depreciation and keep the lifetime of at least 25,000 hours, an efficient heat dissipation mechanism for removing the heat from high power LEDs is demanded. Besides, a LED lamp must include an internal AC/DC power conversion module to convert AC electrical power to DC electrical power since LEDs use DC power as power driving source. The internal power conversion module also generates heat and need timely heat dissipation to guarantee its proper operation. Therefore, a well-designed heat dissipation mechanism for LED lamps should protect the whole lamp including both the LED module and the power conversion module from overheating.

Conventionally, an airtight lamp shell with a large number of fins made of thermal conductive materials is employed as the heat dissipation element for a LED lamp and internal circuits of the LED lamp are located inside the lamp shell. The lamp shell mounts with the LED light source module of the LED lamp to transfer the heat from the LED light source module to the ambient air. Thermal transfer takes place at the external surface of the lamp shell. Therefore, the lamp shell should be designed to have a large surface area. This goal can be reached by using the large number of fins or by increasing the size of the lamp shell itself. However, in order to be interchangeable with conventional incandescent or fluorescent bulbs, the size of LED lamps cannot be very large and the lamp head made of insulating materials such as glass and transparent plastic may occupy a certain part of the lamp body. Accordingly, the lamp shell has very limited contact area with the ambient air, and thereby the heat dissipation effect may not satisfy practical requirements. Moreover, the internal circuits such as the power conversion module also generate heat and need effective heat dissipation to guarantee their proper operations. As the lamp shell is airtight, there is very little air convection in the interior of the lamp shell, resulting in fast overheating of the power conversion module, which frequently fails sooner than the LED light source module.

In view of the above, it is beneficial to have a LED lamp with an enhanced heat dissipation mechanism that effectively increases air convection around the LED lamp and simultaneously cools the LED light source module and the internal circuits of the LED lamp.

### SUMMARY OF THE INVENTION

In the present invention, a LED lamp with an air-permeable shell for heat dissipation is provided. The LED lamp comprises a lamp shell having a top end, a shell body and a bottom end, a LED light source module being bounded on the top end of the lamp shell, a screw base being jointed with the bottom end of the lamp shell, an AC/DC power conversion module located inside the lamp shell. The lamp shell is made of thermal conductive materials and have air-permeable through holes formed on the lamp shell. The thickness of the lamp shell can be in the range of 0.5 mm to 1.5 mm to make sure that heat is conducted properly through the lamp shell to all of its surfaces.

According to an embodiment of the present invention, the bottom end of the lamp shell can be an annular flat disc, the screw base fits to the center of the annular flat disc, and the AC/DC power conversion module can be attached onto the annular flat disc. The lamp shell preferably has a height of 3 cm to 10 cm and a traverse diameter of 2 cm to 7 cm so as to make the LED lamp directly replace conventional incandescent or fluorescent bulbs.

According to another embodiment of the present invention, the LED lamp further comprises a lamp cap covering the LED light source module. The lamp cap has a dome shape and the size of the bottom plane of the lamp cap matches or is less than the size of the top end of the lamp shell. The LED light source module includes a LED lighting die mounted on a metal core printed circuit board, a reflective cup with reflective inner surface sealing the LED lighting die therein, a phosphor layer coating on the reflective cup and a plurality of sub semi-spherical lens disposed on the phosphor layer.

In the LED lamp according to the present invention, the lamp shell is an air permeable shell, so the natural air convection surrounding the LED light source module is improved and the inside surface of the lamp shell also contributes to the heat dissipation in addition to the external surface dissipation. Therefore the contact surface of the lamp shell with the ambient air is significantly increased, thereby enhancing the effect of heat dissipation. Moreover, not only the heat produced by the LED light source module but also the heat from the power module inside the lamp shell can be efficiently dissipated.

### BRIEF DESCRIPTION OF THE DRAWINGS

The present invention can be more fully understood by reading the subsequent detailed description and examples with reference to the accompanying drawings, wherein:

FIG. 1(a) illustrates the side view of the LED lamp according to an embodiment of the present invention;

FIG. 1(b) illustrates the top view of the LED lamp according to an embodiment of the present invention;

FIG. 1(c) illustrates the bottom view of the LED lamp according to an embodiment of the present invention;

FIG. 2(a) illustrates a cross-sectional view of the LED lamp according to an embodiment of the present invention;

FIG. 2(b) illustrates a cross-sectional view of the LED lamp according to another embodiment of the present invention;

FIG. 3(a) illustrates the connection between the lamp shell of the LED lamp and a standard screw base according to an embodiment of the present invention;

FIG. 3(b) illustrates the connection between the lamp shell of the LED lamp and a standard screw base according to another embodiment of the present invention;

FIGS. 4(a) to 4(c) illustrate possible styles of the head of the LED lamp according to the present invention; and

FIGS. 5(a) to 5(d) illustrate some exemplary configurations of the LED light source module to be used in the LED lamp according to the present invention.

### DETAIL DESCRIPTIONS OF THE INVENTION

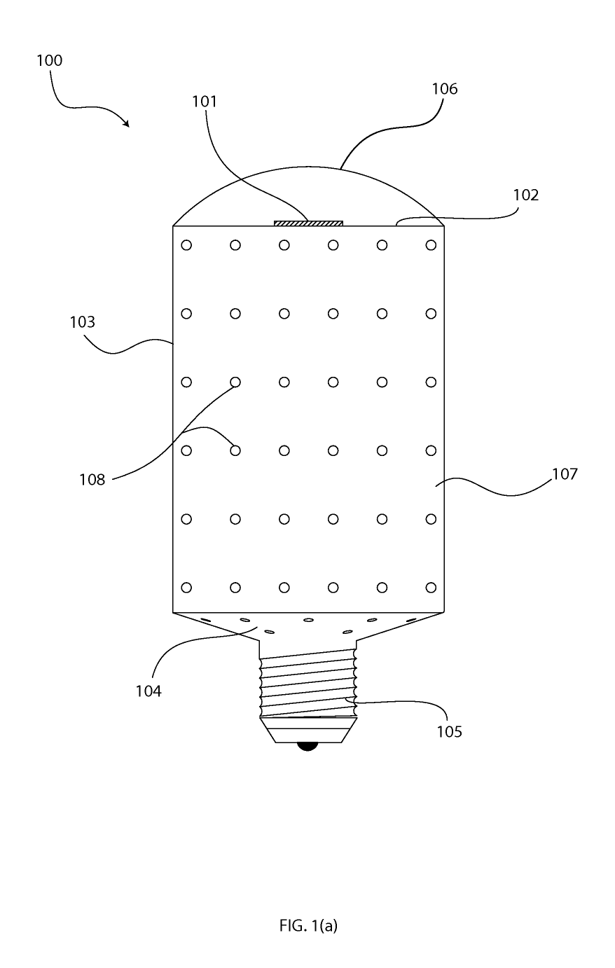

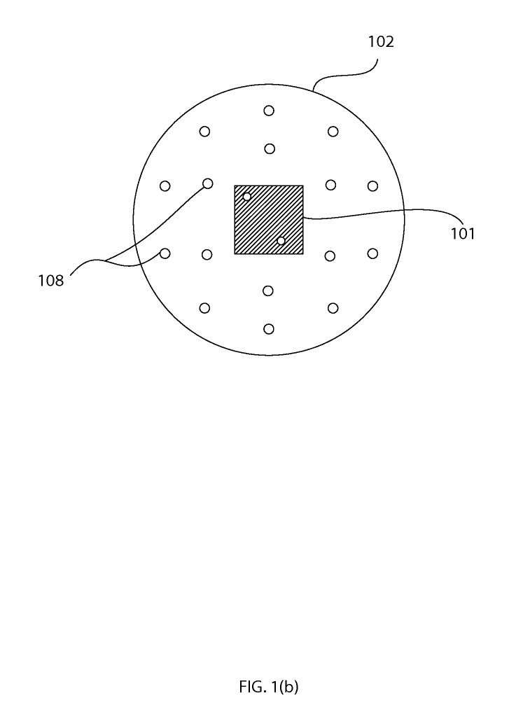

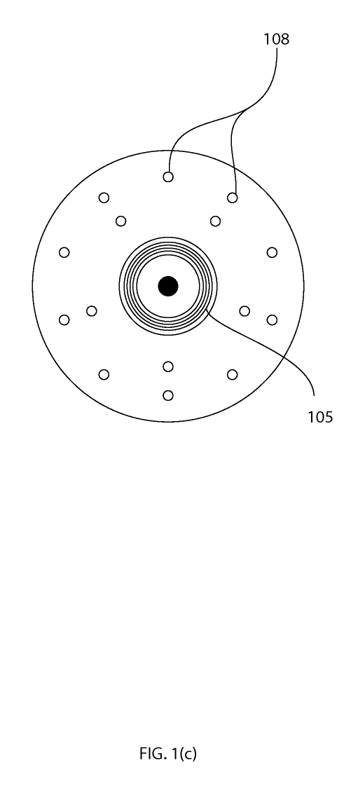

Referring to FIG. 1(a) to FIG. 1(c), the top, side and bottom views of the LED lamp 100 according to an embodiment of the present invention are shown. In the LED lamp 100, a LED light source module 101 is a white light emitting source and bounded onto the top end 102 of the lamp shell 103 by solder, thermal conductive glue or any other bounding method. Preferably, the LED light source module 101 is placed at the center of the top end 102 of the lamp shell 103 and the size of the LED light source module 101 is in the range of 0.5 cm² to 4 cm². The lamp shell 103 is composed of the top end 102, the shell body 107. The bottom end 104 joining the lamp shell 103 is jointed with the screw base 105, forming a lamp base for mounting the LED lamp 100 into a standard AC power outlet. The screw base 105 is a standard E14 or E27 screw base, so that the LED lamp 100 can conveniently replace conventional incandescent or fluorescent bulbs. A dome-shaped cap 106 is optionally disposed at the head of the LED lamp 100 to cover the LED light source module 101.

The top end 102 and the shell body 107 of the lamp shell 103 are made of materials with high thermal conductivity such as Aluminum, Copper, etc., and function as the heat dissipation element for conducting heat from the LED light source module 101 to the surrounding air and thus controlling the junction working temperature of the LED light source module 101. The bottom end 104 joining the lamp shell 103 is made of electrical insulating materials so as to electrically insulate the shell body 107 and the top end 102 of the lamp shell from the screw base 105. In order to enhance the efficiency of heat dissipation, through holes 108 are made on the lamp shell 103. The through holes 108 can be uniformly or non-uniformly formed on the top end 102, the shell body 107 and the bottom end 104 joining the lamp shell 103, and can be circles, ellipses or any other shapes, as long as air can flow freely, more or less, inside the lamp shell 103. Also, the total area of the through holes 108 does not need to be large because the increase of the total area of the through holes 108 will result in the decrease of the contact area of the lamp shell 103 with the ambient air. Since the lamp shell 103 becomes an air permeable shell, the natural air convection surrounding the LED light source module 101 is enhanced, and the inside surface of the lamp shell 103 also contributes to the heat transfer in addition to the external surface transfer. Opening up the lamp inside surface for natural heat convection could significantly increase the contact surface with the ambient air, thereby improving the effect of heat dissipation. The thickness of the lamp shell 103 is preferably designed as 0.5 mm to 1.0 mm, which ensures the heat produced inside the lamp shell 103 can be conducted to the outside surface of the lamp shell 103 and then disseminated to the ambient air. With such a heat dissipation element, not only the heat produced by the LED light source module 101 but also the heat from the power module inside the lamp shell 103 can be efficiently dissipated. In the preferred embodiment, the lamp shell 103 is a cylindrical metal shell, which has a height of 3 cm to 15 cm and a top surface diameter of 2 cm to 7 cm. The LED lamp 100 having the preferably dimensioned lamp shell can directly replace conventional incandescent or fluorescent bulbs. However, it is not intended to limit the shape and the dimension of the lamp shell 103 by the exemplary embodiment. The lamp shell 103 can be designed as a cone shell or any other shell shape, and can be larger or longer to achieve better heat dissipation.

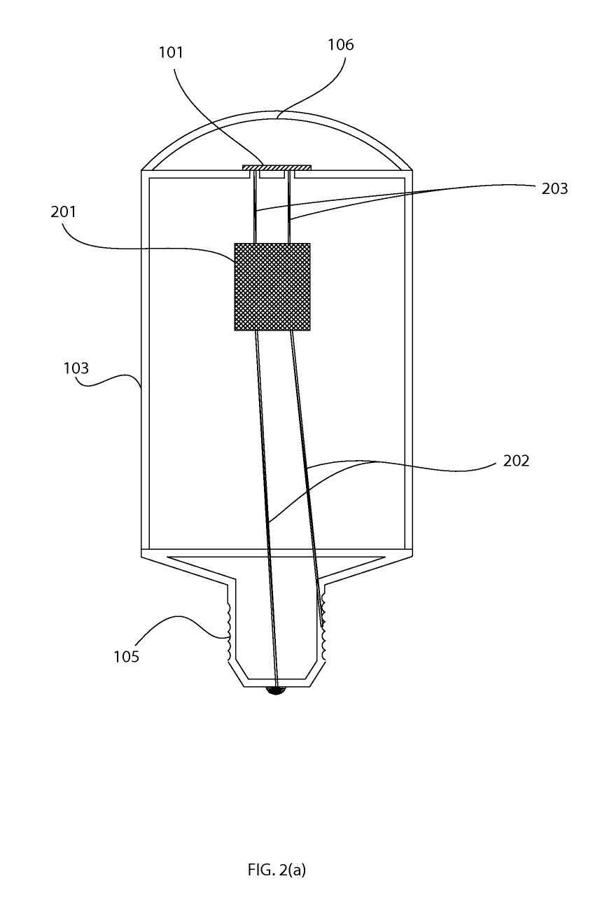

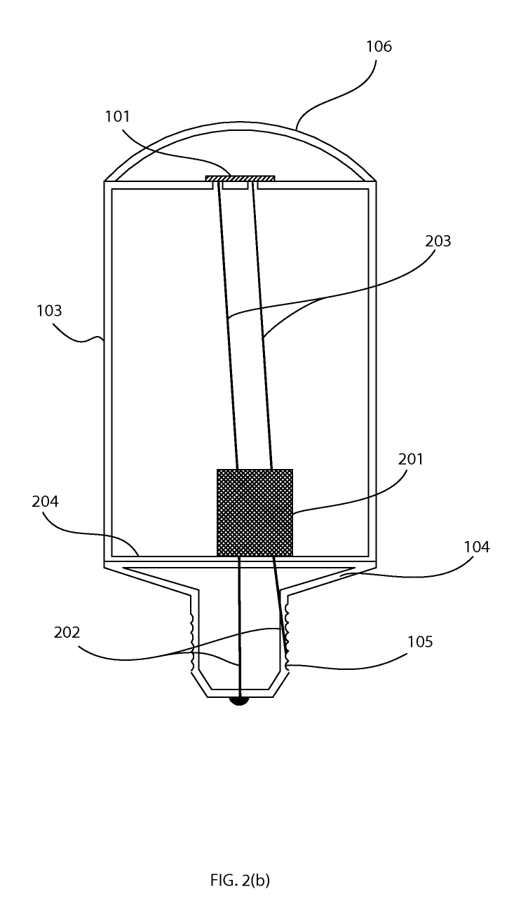

FIG. 2(a) and FIG. 2(b) illustrate a cross-sectional view of the LED lamp 100 according to embodiments of the present invention. LEDs use DC electrical power, so the LED lamp 100 includes an AC/DC conversion module 201 inside the lamp shell 103. A standard AC voltage from the screw base 105 is transmitted to the AC/DC conversion module 201 through the AC power lines 202, and then the generated DC voltage is applied to the LED light source module 101 through the DC power lines 203. The AC/DC conversion module 201 can be any commercially available power conversion module. In case that the AC/DC conversion module 201 is made without an electrically insulating surface, we need make sure that the AC/DC conversion module 201 is electrically insulated from the lamp shell 103. Thus the module can be sit on a disc, which is made of electrical insulating materials and fixed with the lamp shell 103, or alternatively the module can be suspended in the middle of the lamp shell 103 but not touching the lamp shell 103. In the preferred embodiment as illustrated in FIG. 2(a), the AC/DC conversion module 201 is suspended with or without a supporting branch frame to keep it in the position without electrical contact with the lamp shell 103, in order to allow maximum air convection surrounding the AC/DC conversion module 201 and achieve best heat dissipation through all surfaces of the module. In case that the AC/DC conversion module 201 is fabricated with a package surface made of thermally conductive and electrically insulating materials, the AC/DC conversion module can be attached to the shell body 107 of the lamp shell 103, either through a thermally conductive disc located anywhere inside the lamp shell, or directly mounting onto the shell body 107. In the preferred embodiment as shown in FIG. 2(b), the AC/DC conversion module 201 is sit on a thermally conductive disc 204, e.g. a metal disc, which is mount with the shell body 107 and disposed on the bottom end 104 joining the lamp shell 103. The thermally conductive disc 204 also has permeable holes formed on it to improve air convection.

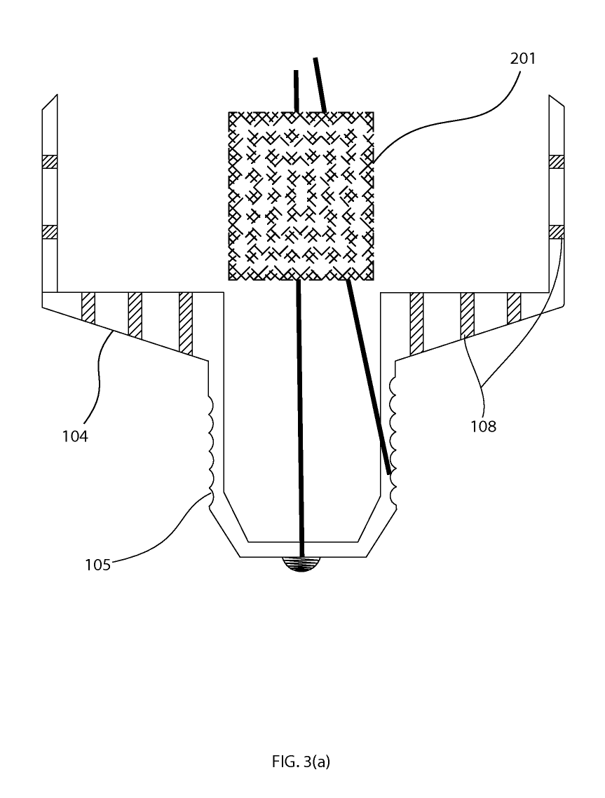

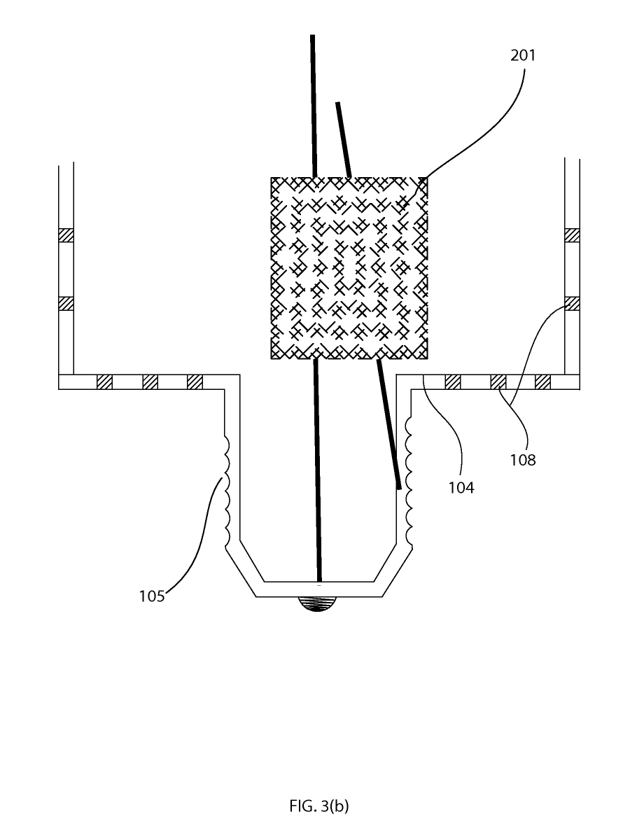

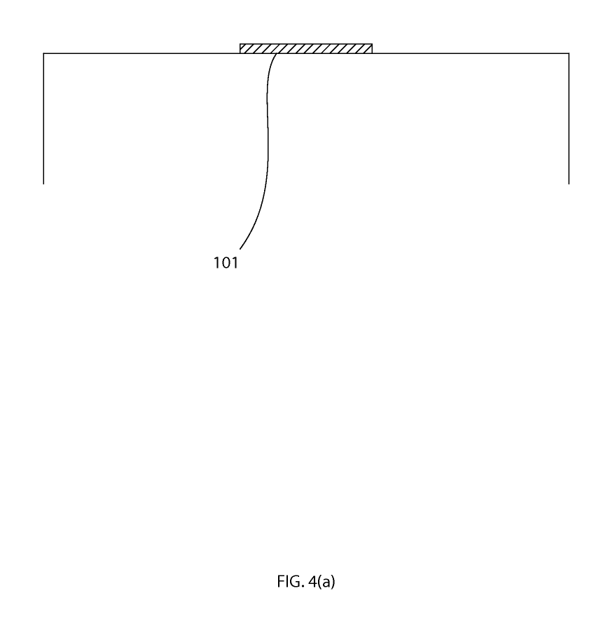

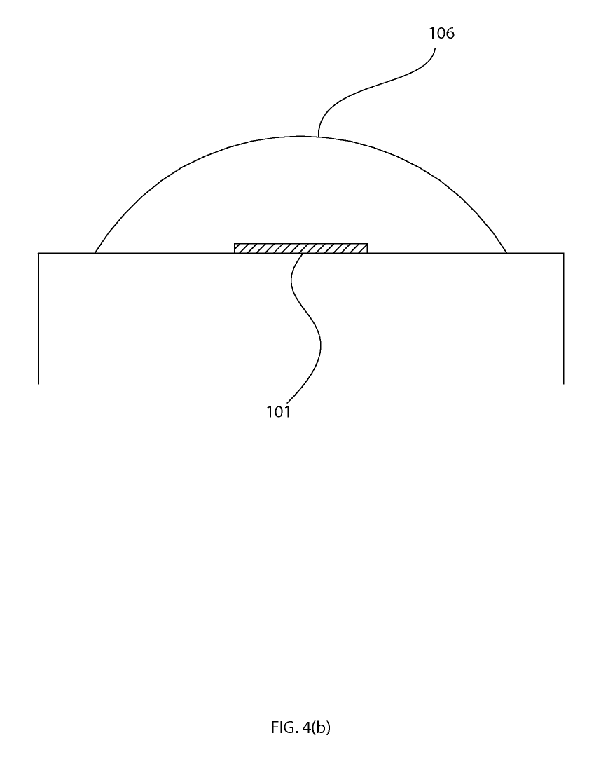

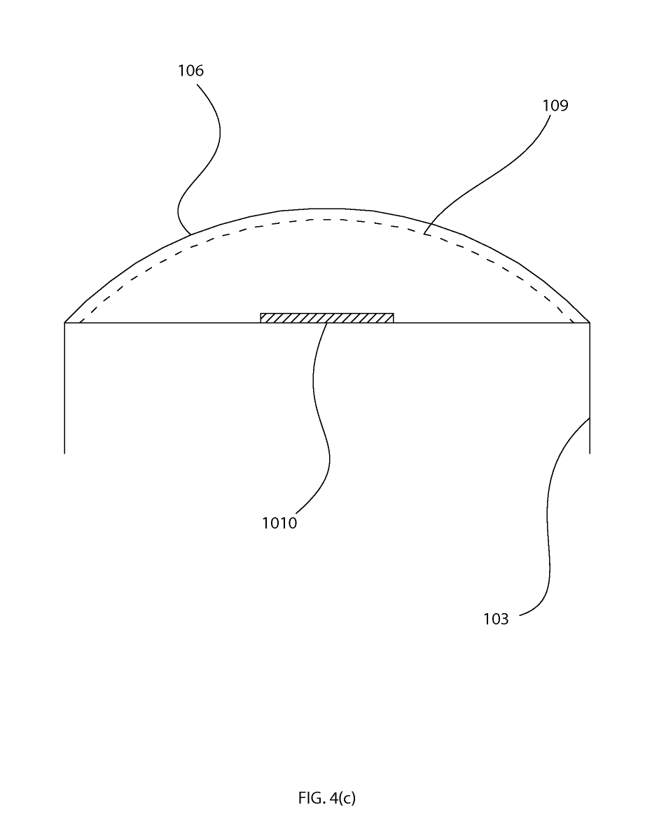

FIG. 3(a) and FIG. 3(b) illustrate the connections between the lamp shell 103 and the screw base 105 according to the present invention. The bottom end 104 joining the lamp shell 103 is jointed with the screw base 105 to form the lamp base for fitting the LED lamp 100 into a standard lamp screw-in socket. The screw base 105 can be a standard E14 or E27 screw base, so that the LED lamp 100 can easily replace conventional incandescent or fluorescent lamps. The bottom end 104 joining the lamp shell 103 can have a cone shape, as shown in FIG. 3(a). The angle between the side surface of the cone and the horizontal plane perpendicular to the body of the lamp shell 103 is in the range of 0° to 45° The bottom of the cone is jointed with the screw base 105, and the top part of the cone (which may be manufactured a solid cone or a shell cone) is made permeable that may be used for holding the AC/DC conversion module 201. When the angle is 0°, the bottom end 104 joining the lamp shell 103 turns to be a flat disc, as illustrated in FIG. 3(b). The flat disc is a permeable disc that may be used for holding the AC/DC conversion module 201, and the screw base 105 is jointed with the bottom end 104 at the center of the flat disc. Please note that the shapes of the bottom end 104 shown in FIG. 3(a) and FIG. 3(b) are only provided for illustrative purpose, and the bottom end 104 can have any other appropriate shape. As shown in FIG. 1(a), a lamp cap 106 made of transparent materials such as glass or transparent plastic, which serves to diffuse the emitting light, is applied to cover the LED light source module 101. Referring to FIG. 4(a) to FIG. 4(c), the lamp cap 106 is optionally applied and the shape and the size of the lamp cap 106 are also variable depending on design desires. For instance, the lamp cap 106 can be in a dome shape, and the dimension of the lamp cap 106 fits with that of the lamp shell 103, i.e. the diameter of the bottom plane of the lamp cap 106 is exactly the same as the diameter of the top end of the lamp shell 103. Alternatively, the diameter of the bottom plane of the lamp cap 106 can be less than the diameter of the top end of the lamp shell 103. The height of the lamp cap 106 can be arbitrarily selected. In addition, when we use a blue light emitting source 1010 and a phosphor layer 109 to make a white light LED light source module, the phosphor layer 109 can be coating on the interior surface of the lamp cap 106 to convert blue light into white light, as shown in FIG. 4(c).

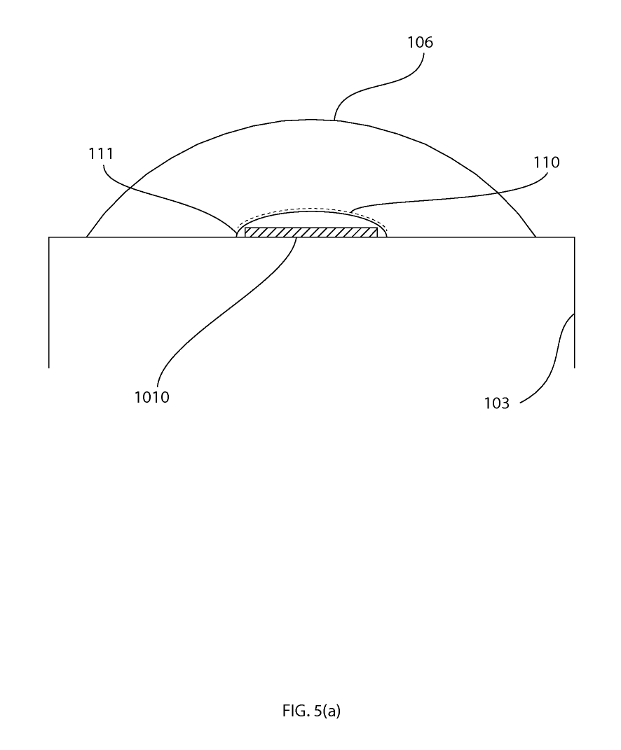

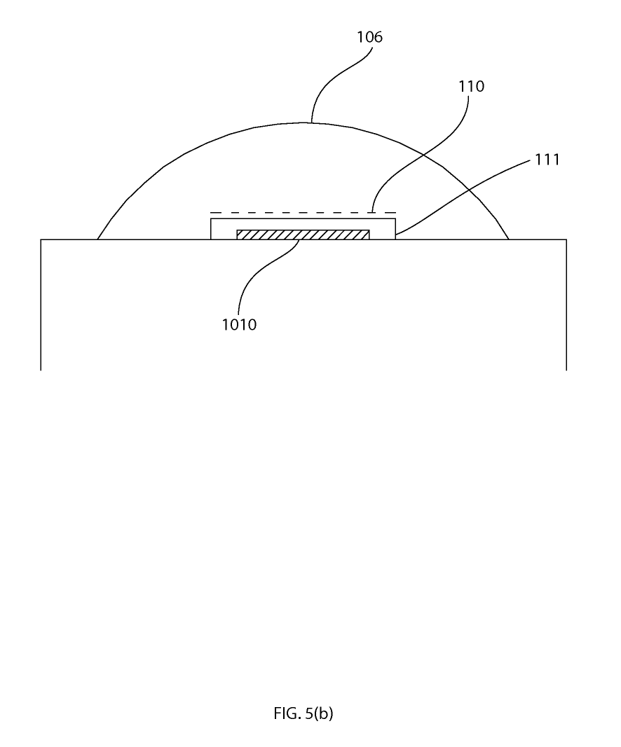

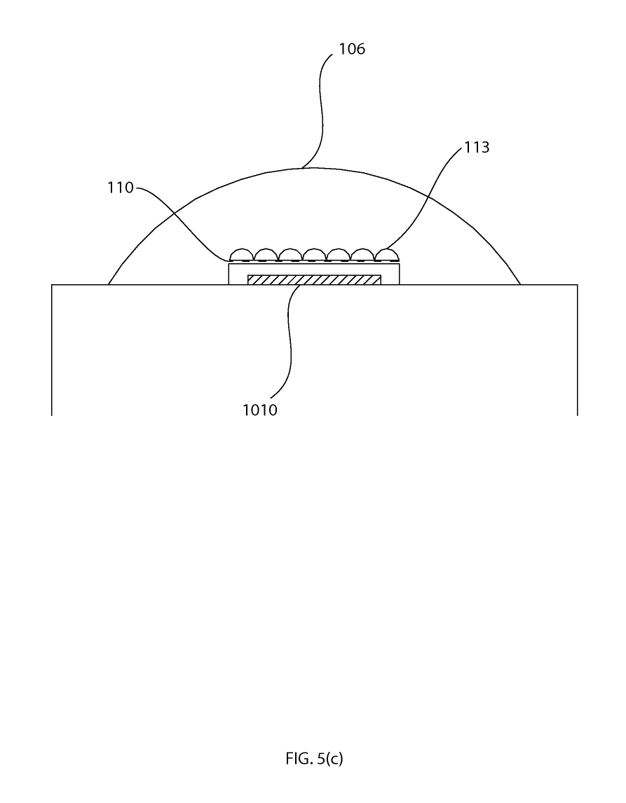

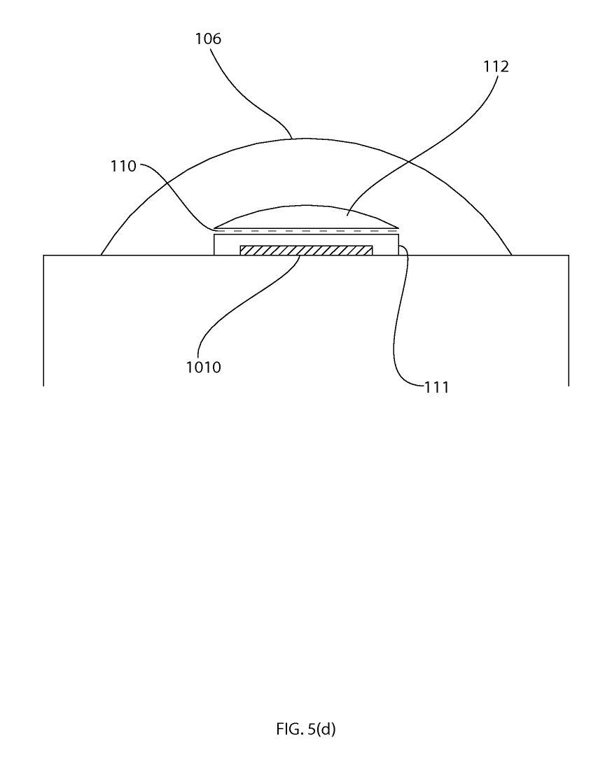

FIGS. 5(a) to 5(d) illustrate some exemplary configurations of the white light LED light source module 101 to be used in the LED lamp 100 according to the present invention. General purpose lighting needs white light. A feasible and economic method to emit white light from LEDs is to use LEDs emitting short wavelength light (usually blue light) in combination with a phosphor, which absorbs a portion of the blue light and emits a broader spectrum of white light. Such phosphor converted LEDs can be used as the white light LED light source module 101 in the LED lamp 100 according to the present invention. As shown in FIGS. 5(a) to 5(d), several illustrative variations of the phosphor converted LED light source module are provided. In FIG. 5(a), the LED light source module is composed of available blue light LED module 1010, an electrically isolating cup 111 and a phosphor layer 110. In this LED light source module, the phosphor layer 110 can be coated on the dome-shaped electrically isolating cup 111, which seals the blue light LED module 1010 and has a reflective inner surface. The phosphor layer 110 could also be directly coated on the blue light LED module 1010 in other embodiments. The LED light source module of FIG. 5(b) is very similar to that of FIG. 5(a). The only difference is that the electrically isolating cup can be a cylinder or a rectangular shape. In FIG. 5(c) and FIG. 5(d), a plurality of sub semi-spherical lens 113 or a semi-spherical lens 112 could be applied to achieve better optical effect. In the embodiments, the phosphor layer 110 can be alternatively coating at the bottom surface of the semi-spherical lens 112 or the plurality of sub semi-spherical lens 113. Please note that the configurations of the LED light source module given in FIGS. 5(a) to 5(d) are only for the illustrative purpose. In practice, the LED light source module 101 in the LED lamp 100 can be any kind of available LED lighting module.

According to the present invention, the lamp shell with through holes is provided to dissipating the heat from the working LED light source module and the AC/DC power conversion module. The main body of the lamp shell is made of thermal conductive materials, and the bottom of the lamp shell is mounted with a standard bulb base so that the LED lamp can be easily interchangeable with conventional bulbs. There is no specific requirement about the shapes of the lamp shell and the through holes thereon. Also, the through holes could be formed anywhere on the lamp shell and the total area of the through holes is not necessary to be very large, as long as it is allowed to have the natural air convection inside the lamp shell.

While the present invention has been described in conjunction with preferred embodiments thereof, it is evident that many alternatives, modifications and variations will be apparent to those skilled in the art. It is therefore intended that the foregoing detailed description be regarded as illustrative rather than limiting, and that it should be understood that it is the appended claims, including all equivalents, that are intended to define the scope of this invention.

1. A LED lamp with an air-permeable shell for heat dissipation, comprising:
a lamp shell;
the lamp shell comprising a top end, a shell body, and a bottom end;
a LED light source module being bounded on the top end of the lamp shell;
a screw base being jointed with the bottom end of the lamp shell;
an AC/DC power conversion module located inside the lamp shell; and
the lamp shell being made of thermal conductive materials and having air-permeable through holes formed on the lamp shell.

2. The LED lamp with an air-permeable shell for heat dissipation according to claim 1, wherein the shell body of the lamp shell has a cylindrical shape.

3. The LED lamp with an air-permeable shell for heat dissipation according to claim 1, wherein the AC/DC power conversion module has a package surface made of thermally conductive and electrically insulating materials, a thermally conductive disc is mounted with the shell body and disposed on the bottom end of the lamp shell, and the AC/DC power conversion module is fixed on the thermally conductive disc.

4. The LED lamp with an air-permeable shell for heat dissipation according to claim 1, wherein the thickness of the lamp shell is in the range of 0.5 mm to 1.5 mm.

5. The LED lamp with an air-permeable shell for heat dissipation according to claim 1, wherein the screw base is a standard E14 or E27 screw base.

6. The LED lamp with an air-permeable shell for heat dissipation according to claim 1, wherein the lamp shell has a height of 3 cm to 15 cm and a traverse diameter of 2 cm to 7 cm.

7. The LED lamp with an air-permeable shell for heat dissipation according to claim 1, further comprising a lamp cap covering the LED light source module; and
the lamp cap having a dome shape and the size of a bottom of the lamp cap matching or being less than the size of the top end of the lamp shell.

8. The LED lamp with an air-permeable shell for heat dissipation according to claim 1, wherein the LED light source module includes a blue light LED lighting module, an electrically isolating cup with reflective inner surface sealing the blue light LED lighting dies therein, a phosphor layer coating on the reflective cup and a plurality of sub semi-spherical lens disposed on the phosphor layer.

9. A LED lamp with an air-permeable shell for heat dissipation, comprising:
a lamp shell;
the lamp shell comprising a top end, a cylindrical shell body and a bottom end;
a LED light source module being bounded on the top end of the lamp shell;
a screw base being jointed with the bottom end of the lamp shell;
an AC/DC power conversion module located inside the lamp shell;
the lamp shell being made of thermal conductive materials and having air-permeable through holes formed on the lamp shell; and
the thickness of the lamp shell being in the range of 0.5 mm to 1.5 mm.

10. The LED lamp with an air-permeable shell for heat dissipation according to claim 9, wherein the AC/DC power conversion module has a package surface made of thermally conductive and electrically insulating materials, a thermally conductive disc is mounted with the shell body and disposed on the bottom end of the lamp shell, and the AC/DC power conversion module is fixed on the thermally conductive disc.

11. The LED lamp with an air-permeable shell for heat dissipation according to claim 9, wherein the screw base is a standard E14 or E27 screw base.

12. The LED lamp with an air-permeable shell for heat dissipation according to claim 9, wherein the lamp shell has a height of 3 cm to 15 cm and a traverse diameter of 2 cm to 7 cm.

13. The LED lamp with an air-permeable shell for heat dissipation according to claim 9, further comprising a lamp cap covering the LED light source module, the lamp cap having a dome shape and the size of a bottom of the lamp cap matching or being less than the size of the top end of the lamp shell.

14. The LED lamp with an air-permeable shell for heat dissipation according to claim 9, wherein the LED light source module includes a blue light LED lighting dies, an electrically isolating cup with reflective inner surface sealing the blue light LED lighting die therein, a phosphor layer coating on the reflective cup and a plurality of sub semi-spherical lens disposed on the phosphor layer.

15. A LED lamp with an air-permeable shell for heat dissipation, comprising:
a lamp shell;
the lamp shell comprising a top end, a cylindrical shell body and a bottom end;
a LED light source module being bounded on the top end of the lamp shell;
a screw base being jointed with the bottom end of the lamp shell;
an AC/DC power conversion module located inside the lamp shell;
the lamp shell being made of thermal conductive materials and having air-permeable through holes formed on the lamp shell;
the AC/DC power conversion module having a package surface made of thermally conductive and electrically insulating materials;
a thermally conductive disc being mounted with the shell body and disposed on the bottom end of the lamp shell; and
the AC/DC power conversion module being fixed on the thermally conductive disc.

16. The LED lamp with an air-permeable shell for heat dissipation according to claim 15, wherein the thickness of the lamp shell is in the range of 0.5 mm to 1.5 mm.

17. The LED lamp with an air-permeable shell for heat dissipation according to claim 15, wherein the screw base is a standard E14 or E27 screw base.

18. The LED lamp with an air-permeable shell for heat dissipation according to claim 15, wherein the lamp shell has a height of 3 cm to 10 cm and a traverse diameter of 2 cm to 7 cm.

19. The LED lamp with an air-permeable shell for heat dissipation according to claim 15, further comprising a lamp cap covering the LED light source module, the lamp cap having a dome shape and the size of a bottom of the lamp cap matching or being less than the size of the top end of the lamp shell.

20. The LED lamp with an air-permeable shell for heat dissipation according to claim 15, wherein the LED light source module includes a blue light LED lighting module, an electrically isolating cup with reflective inner surface sealing the blue light LED lighting die therein, a phosphor layer coating on the reflective cup and a plurality of sub semi-spherical lens disposed on the phosphor layer.
